(19) United States
(12) Patent Application Publication
(10) Pub. No.: US 2014/0331501 A1
(43) Pub. Date: Nov. 13, 2014

(54) Electrically Operated Shaver With Replaceable Cutting Device

(71) Applicant: Braun GmbH, Kronberg (DE)

(72) Inventors: Andreas Erndt, Kelkheim (DE); Joachim Krauss, Pfungstadt (DE); Diana Kappes, Eppstein (DE); Nicolas Salomez, Eschborn (DE); Daniel Dietzel, Kelkheim (DE)

(21) Appl. No.: 14/444,061

(22) Filed: Jul. 28, 2014

Related U.S. Application Data
(63) Continuation of application No. 13/176,163, filed on Jul. 5, 2011, now abandoned.

(51) Int. Cl. B26B 19/12; B26B 21/40; B26B 21/22

(52) U.S. Cl. CPC B26B 19/12; B26B 21/225; B26B 21/405; B26B 21/4062
USPC 30/43.9

(57) ABSTRACT

The invention relates to an electrically operated shaver with at least one upper blade attachable to a shear head frame by means of a removable frame, on the underside of which lies a linearly oscillating lower blade. The lower blade is connected via a clutch engagement with an oscillating bridge mounted on either side on the shaver by resilient arms. The oscillating bridge is also connected to the drive shaft of an electric motor via a gear mechanism, so that when the motor is running, the oscillating bridge, and thus also the lower blade, is set in linear reciprocating motion. According to the invention, the resilient arms of the oscillating bridge are arranged on the removable frame. In this way, the oscillating bridge which often wears out quickly, can also be replaced when the cutting device is replaced. This prevents malfunction and potentially high repair expenses, thus reducing costs.

### FIELD OF THE INVENTION

The invention relates to an electric shaver and a replaceable cutting system for it.

### BACKGROUND OF THE INVENTION

Electric shavers are known from DE 1 185 508 C and from DE 33 15 642 C1 and from DE 27 49 936 C3 in which, to produce a linear oscillating motion of the lower blade, an oscillating bridge with resilient arms is provided which is connected via a gear mechanism to an electric rotary motor. The gear mechanism preferably consists of a cam designed on a rotating drive shaft of the motor which, according to DE 1 185 508 C, engages in a slot at the bottom of the oscillating bridge, so that the rotational motion is transmitted to the oscillating bridge as an oscillating motion.

In DE 33 15 642 C1 and DE 27 49 936 C3, in contrast, the cam engages into an alignment hole resilient lever on the oscillating bridge, so that, on the one hand, those movements running perpendicular to the direction of displacement B (FIG. 1 of DE 33 15 642 C1) are absorbed by the bending of the resilient lever, and on the other hand, those movements running in the direction of displacement B, are conveyed into the oscillating bridge, thus reproducing this linear oscillating motion in the direction of displacement B according to FIG. 1. This linear oscillating motion is transferred directly to the lower blade when the clutch is engaged, which thus slides along the underside of a perforated upper blade. The resilient arms of the oscillating bridge are mounted on the drive motor housing.

An electrically operated shaver is also known from DE 195 39 687 C2 in which two oscillating bridges mounted in the housing, each with two resilient arms attached, one oscillating bridge driving the lower blade of a first cutting device, preferably a short hair cutter, and the other oscillating bridge driving the lower blade of another cutting device, preferably a linearly oscillating trimmer. The oscillating bridges are firmly anchored in the motor housing.

An electrically operated shaver is also known from DE 43 C1 41 392 C1 in which, to achieve a linear oscillating motion, the cam engages into a groove formed in one of the two resilient arms. Here again, the resilient arms are securely mounted to the motor housing of the shaver.

In all the aforementioned citations, the resilient arms are designed so that they typically outlast the life of a shaver, that is, they must withstand millions of vibrations, so as not to cause premature failure of the shaver. For this reason, high quality materials are used in the oscillating bridge. This results in increased material costs. On the other hand, higher installation costs are incurred if, due to high load alternation, a defect occurs in the supporting arms of the oscillating bridge, necessitating its replacement.

The object of the invention is to now avoid the above disadvantages and to create a shaver and a replaceable cutting system for it which has is highly functional, cost effective, works quietly and at the same time delivers good shave results and its oscillating bridge can be easily replaced without major assembly costs.

### SUMMARY OF THE INVENTION

According to the invention, this object is achieved by a shaver according to the present invention and a replaceable cutting device for it. As a result, now, according to the invention, with each change of a used upper blade (which is a very thin shaving foil) or lower blade, the oscillating bridge is also replaced, thus renewing the oscillating bridge with its supporting resilient arms on which both the upper and the lower blade-bearing frames are mounted or arranged, also called a shaving cartridge.

The removable frame or shaving head cartridge with upper and lower blades and with integrated oscillating bridge is simply clipped into the shaving head, as is generally known in the prior art, wherein the clutch engagement on the motor side then engages with the oscillating bridge. Belonging to this kind of prior art are, for example, Shaver 70S (Series 7) or the “Pulsonic” shaver (Series 9000), produced and distributed by the applicant himself, which are equipped with a shaving cartridge, which should preferably be changed every 18 months to provide a continuously optimum shave. The removable frame according to the invention can either be mounted in one place on a shaving head frame attached to a fixed shaver housing, or it can also be pivotally mounted on a pivot frame, which in turn is pivotally mounted on a housing head support.

With the invention, now less high-strength materials and less constant flex resilient materials can be selected since the cutting device is replaced at given time intervals anyway. In this way, high repair costs are avoided. The invention can be used for all shavers marketed by the applicant, in which the upper and lower blades are incorporated as an integral part of the removable frame or of the shaving head cartridge.

Advantageously, the resilient arms with the oscillating bridge are essentially W-shaped in cross section, wherein the two outer legs form the resilient arms. This embodiment of oscillating bridge and resilient arms has proven to remain elastic especially long-term, which also results in simple production as an injection molded plastic part. This shape yields a symmetrical design, with the central axis passing through the intersection of the two inner legs. Because of the W-shape, the two outer resilient legs can be moved down sufficiently far from the blade to create enough space for the clutch to engage between the lower blade and the oscillating bridge and for the coupling of the gear mechanism to be arranged between the oscillating bridge and the drive unit. Although the clutch engagement between the lower blade and the oscillating bridge after mounting the removable frame always makes a solid connection, the clutch engages the oscillating bridge to the gear mechanism only when the removable frame, with upper and lower blade on the cutting head, is mounted or clipped to the shaving head of a shaver.

If the free ends of the resilient arms are joined to the removable frame as a single piece, the removable frame with the resilient arms can preferably consist of a plastic injection molded component. In this connection, the oscillating bridge itself could well be a stamped bending mold, which is joined to the resilient arms in a further manufacturing step, for example by welding, punching, riveting, bolting or the like.

If the oscillating bridge is integrally joined to the resilient arms, the removable frame can be formed as a single molded component both with the resilient arms and with the oscillating bridge. For this purpose, particularly cost effective injection tools are available, in the cavity of which a plastic material is injected to form the removable frame with the oscillating bridge and the resilient arms. Polyphenylene sulfide (PPS) has proven to be a particularly tough, durable, and yet cost effective elastic material. Of course, other plastics are possible, but only if they meet the test requirements for such high frequency vibrating elastic arms and for frames of this type.

It is advantageous that the removable frame form a single component with the upper blade and lower blade and with the resilient arms and the oscillating bridge, that this component be detachably secured to a pivot frame, that the pivot frame be pivotally mounted on a head carrier and that the head support be part of a shaver housing. In this way, a shaver is produced having a pivot frame on the head support, into which the cutting unit is integrated, and which is detachably joined to enable it to be quickly and easily replaced or to be quickly disassembled for cleaning. But of course, the invention can also be arranged in a head support that is fixed on the housing of a shaver. By pivoting the pivot frame in which its pivot axis is parallel to the linear oscillating motion of the lower blade, especially good shave results are obtained because the perforated foil-like upper blade can optimally follow the contour of the skin surface.

In order to create a simple drive connection from the drive motor to the oscillating bridge, both the head support and the pivot frame are penetrated by a drive member having a longitudinal slot on the lower end into which a cam (4) engages, and the protruding end of the pivot frame (28) engages in a receptacle (41). The cam forms the gear mechanism for the cutting device in the removable frame with the drive member and its engagement with the oscillating bridge.

A further embodiment of the invention provides that the gear mechanism and the clutch engagement be connected with one another by a rocker arm and that the rocker arm be pivotally mounted about a rotational axis. This additional arrangement according to the invention makes it possible for the resilient arms connected to the oscillating bridge to be shorter. This results in a lower space requirement. By using the rocker arm, the displacement path of the lower blade can be achieved with particularly small-scale cam design in the gear mechanism.

When the rotation axis is on the central axis of the rocker arm, the result is an absolutely even movement between the left and right sides of the rocker arm and thus also on the lower blade.

If the axis of rotation intersects at that point of the central axis of the rocker arm at which the central or longitudinal axes of the resilient arms intersect in the idle position of the shaver, there is no relative movement of the rocker arm on the clutch engagement between the oscillating bridge and the lower blade. In this way, the smallest bending deformations also occur on the resilient arms, which optimizes the dynamic fatigue behavior of the resilient arms.

It is advantageous for the axis of rotation of the rocker arm to run perpendicular to the linear oscillating motion of the lower blade so that a symmetrical component results. At the same time, the frictional losses should be as low as possible in the moving components, such as in the clutch engagement and gear mechanism. It is advantageous for the axis of rotation to be formed, on the one hand, by a borehole through the rocker arm and, on the other hand, by an alignment pin sliding through the hole, wherein the alignment pin is mounted on the pivot frame.

In a preferred embodiment, the invention relates not only to an electric shaver, but also to a replaceable cutting device, which is tradable as a spare for such a shaver. Because of the removable cutting device according to the invention, complex repairs and the necessarily associated high repair costs are avoided.

It is advantageous if the oscillating bridge with the resilient arms is integrally joined as one piece with the removable frame. In this way, the removable frame with the oscillating bridge can be produced extremely inexpensively as a separate injection molded plastic part.

### BRIEF DESCRIPTION OF THE DRAWINGS

Several embodiments of the invention are shown in the drawings and are clarified in more detail below. In the drawings:

FIG. 1 is a perspective sketch of a head support with pivot frame with a raised framework with integrated upper and lower blade and oscillating bridge, but in a greatly enlarged scale,

FIG. 2 is an large scale partial longitudinal section through the configuration according to the invention with the oscillating bridge in the initial position; only the parts characterized in the invention are shown roughly sketched,

FIG. 3 shows a large scale, slightly perspective view from right front of the oscillating bridge with the rocker arm and cam shaft in the initial position of the shaver,

FIG. 4 is a perspective sectional view of FIG. 3, but from approximately half-right and slightly from above and

FIG. 5 is a slightly perspective view from right front of the oscillating bridge and the rocker arm with cam shaft corresponding to FIG. 3, wherein, however, the rocker arm is rotated counter-clockwise around the rotational axis D so that the clutch member has taken a left-shifted position due to the elastic deformation of the oscillating bridge.

### DETAILED DESCRIPTION OF THE INVENTION

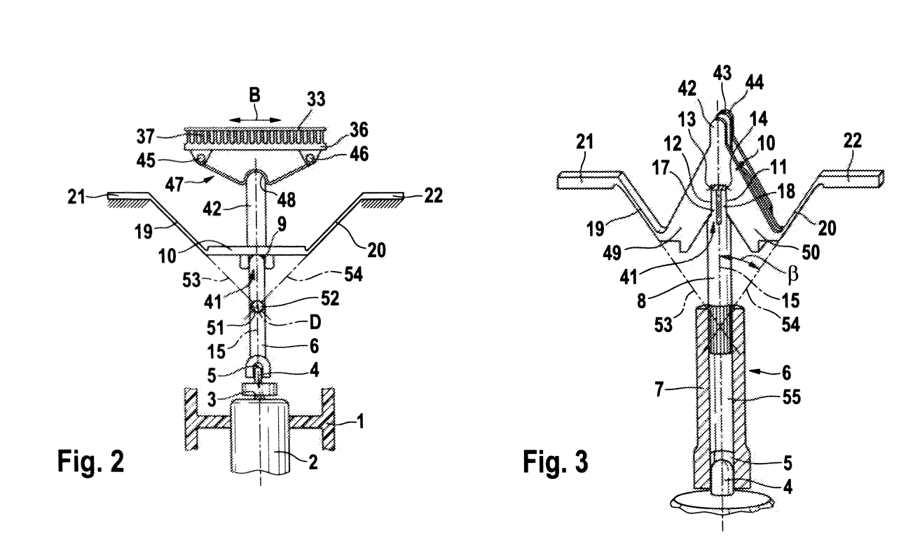

According to FIG. 2, on an electric drive motor (partially shown) in a housing 1 (shown only to some extent) of a shaver (not shown in detail), is a drive shaft 3 with a cam 4 protruding from the upper side. The cam 4 engages in a longitudinal slot 5 running perpendicular to the plane of projection on the lower free face-end of a rocker arm 6. Above the longitudinal slot, the rocker arm 6 swivels easily about a rotational axis D through angle a (FIG. 5), counter-clockwise in the plane of projection.

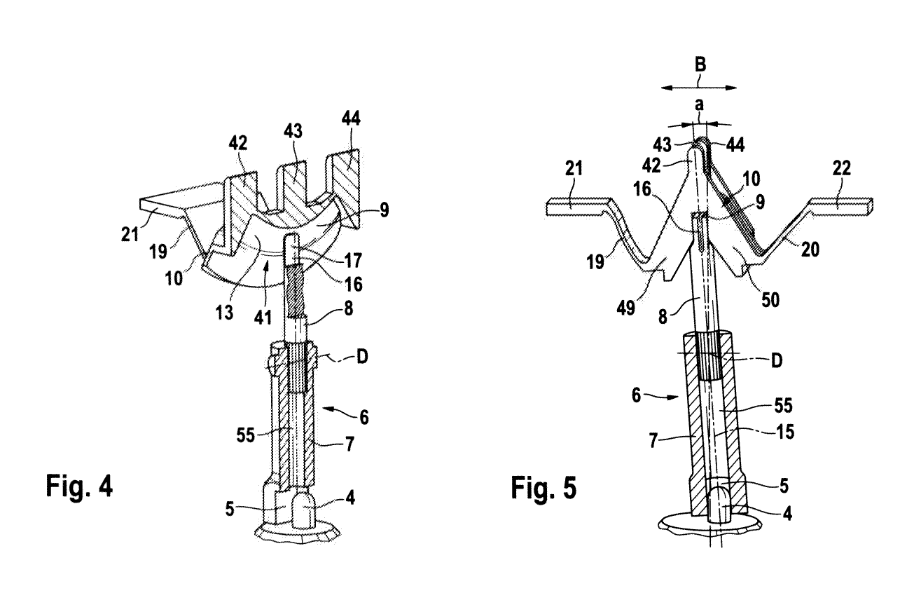

According to FIGS. 3 through 5, the rocker arm 6 is formed in two parts, wherein the lower section is formed by a sleeve 7, on the lower free end of which the longitudinal slot 5 is configured. The sleeve 7 has a central longitudinal borehole 55, into which a pin 8, preferably metal, is pressed. The upper free end of the cylindrical pin 8, according to FIGS. 2 through 5, is preferably flattened on both sides and engages flush in another longitudinal slot 9 which is formed in the center of an oscillating bridge 10. The flattened areas form lateral flattened sides 11, 12 which run parallel to walls 13, 14 of the other longitudinal slot 9, according to FIG. 3 through 5. Symmetrical to the longitudinal axis 15 of pin 8 at the upper end, a slot 16 open towards the free end is introduced, which divides the free end of the rocker arm 6 into two bars 17, 18. The two bars 17, 18 slide along walls 13, 14 of the other longitudinal slot 9 with virtually no play and easily can absorb sudden shocks elastically.

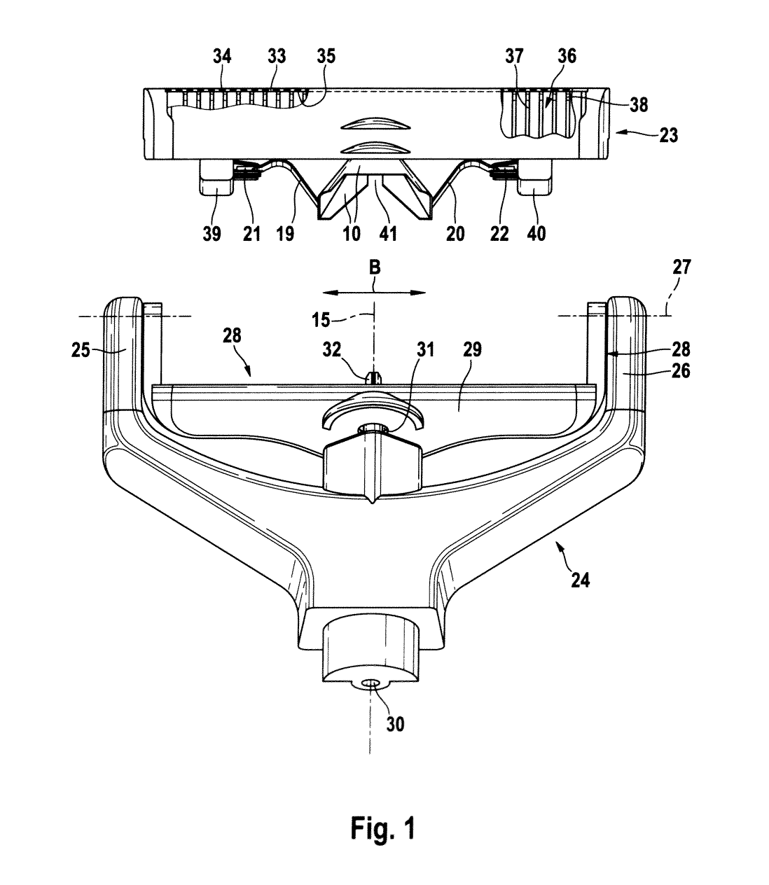

As FIGS. 3 through 5 also show, the oscillating bridge 10 with its resilient arms 19, 20 formed at its free ends is essentially W-shaped in cross-section. At their free ends, the resilient arms 19, 20 have thickened horizontal sections 21, 22 opposite the resilient arms 19, 20 preferably formed as strips and joined to a removable frame 23, for example, by adhesion or welding, etc., as shown in FIG. 1. However, sections 21, 22 can also preferably be joined as one piece with the removable frame 23 by being molded in an injection mold together with the removable frame 23.

As FIG. 3 further shows, at rest the resilient arms 19, 20 extend straight along the longitudinal axes 53, 54. If the longitudinal axes 53, 54 are lengthened down beyond resilient arms 19, 20, they intersect at or near pivot point D on the longitudinal axis 15 of the rocker arm 6. Resilient arms 19, 20 form an angle β of 15° to 60°, preferably 30°, with longitudinal axis 15.

The oscillating bridge 10 itself is V-shaped and is formed by two inner legs 49, 50, on the connecting point of which on one side the coupling members 42, 43, 44 are arranged and on the other, bottom side, the receptacle is designed as a longitudinal slot 9. In FIGS. 2 through 5, the fork-shaped pivot frame 28 and the head support 24, as shown in FIG. 1, are not shown for simplicity. Only one section of the shaver housing 1 is indicated in FIG. 2.

FIG. 1 shows the head support 24, which is forked and on its fork-shaped rods 25, 26 a likewise forked pivot frame 28 is pivotally mounted about a pivot axis 27 at predetermined limits. The head support 24 is part of a housing of a shaver, not shown in FIG. 1 but indicated in FIG. 2, in which the drive motor 2 and all electrical components (not shown) are integrated. Both the head support 24 and the middle section 29 of the forked pivot frame 28 are penetrated by mutually aligned holes 30, 31, forming a common longitudinal axis 15. The holes 30, 31 are penetrated by a drive shaft 32 which at its lower end (not shown) preferably has a longitudinal slot 5, likewise according to FIGS. 3 through 5, connected with the cam 4 of drive shaft 3 of a drive motor 2. With the aid of this gear mechanism, the upper end of the drive shaft 32 performs a linear oscillating motion in direction B.

According to FIG. 1, above the pivot frame 28 is a removable frame 23, which is delimited from above and outside by at least one convexly curved perforated foil 33. The shaving foil 33 has many small holes 34, only some of which are vaguely indicated. On the underside 35 of the shaving foil 33 closely spaced adjacent blades 37 lie on the peripheral surfaces 38 perpendicular to the direction of displacement B. Again, only a small portion of lower blade 36 is vaguely indicated. The lower blade 36 is guided in removable frame 23 in the guide direction B over guide elements, not shown. Rods 39, 40 protrude downward from the removable frame 23 on which sections 21, 22 of the resilient arms 19, 20 are arranged. In the center, oscillating bridge 10 formed as a unit with the resilient arms 19, 20, has a downwardly open receptacle 41, into which the free end of the drive shaft 32 engages in the assembled state of the removable frame 23 on the pivot frame 28.

According to FIGS. 3 through 5, in the middle near the top of the oscillating bridge 10, three coupling members 42, 43, 44 arranged in a row behind one another engage without clearance in corresponding receptacles of three lower blades (not illustrated). This is the case if the removable frame 23 is provided with three adjacent cutting devices simultaneously driven to oscillate over the common swing bridge. This is the case, for example, with the 70S (Series 7) or “Pulsonic” (Series 9000) shavers marketed by the applicant. According to FIG. 1, the removable frame 23 is joined to the pivot frame 28 with locking elements (not shown), but is still removable.

FIG. 2 additionally shows how the lower blade 37, for example, can be joined with a coupling member 42. For this purpose, a shaped spring 47 is hinged at two pivot points 45, 46 on the bottom blade 37, the centrally positioned spherical cap 48 of which pivotally engages coupling member 42 joined to swing bridge 10.

FIG. 5 shows a sketch of approximately how the resilient arms 19, 20 can deform when the rocker arm 6 is swiveled through the angle a counterclockwise about its rotational axis D. On the return stroke, the same angle is reached to the right of longitudinal axis 15, corresponding to the maximum amplitude of oscillating bridge 10. The length of the other longitudinal slot 9 indicates the size of the pivot angle of removable frame 23.

As only suggested in FIG. 2, the bearing of the rocker arm 6 in D is designed as a hole 51 in the rocker arm perpendicular to the plane of projection, in which a pin or peg 52 engages without clearance. The pin 52 is fixed to the shaver housing 1 or to some other stationary part of the shaver. Instead of a hole 51 in the rocker arm 6, pin 52 (not shown) may also extend out of the rocker arm on both sides, which engage in holes formed in the housing 1 (not shown). Of course, in this connection other embodiments of bearings are also conceivable.

Finally, please note that the same reference numbers were selected for identical parts in FIGS. 1 through 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electrically operated shaver with at least one upper blade attachable to a shear head frame by means of an removable frame, on the underside of which lies a linearly oscillating lower blade connected via a clutch engagement with an oscillating bridge mounted on the shaver on either side by resilient arms and connected to the drive shaft of an electric motor via a gear mechanism, so that when the motor is running, the oscillating bridge and thus also the lower blade is set into linear reciprocating movement, wherein the resilient arms of the oscillating bridge are configured on the removable frame.

2. The shaver according to claim 1, wherein the resilient arms with the oscillating bridge are essentially W-shaped in cross section, wherein the two outer legs form the resilient arms and the two inner legs form the oscillating bridge.

3. The shaver according to claim 1, wherein the free ends of the resilient arms are integrally joined to the removable frame.

4. The shaver according to claim 1, wherein the oscillating bridge is integrally joined to the resilient arms.

5. The shaver according to claim 3, wherein the resilient arms, the oscillating bridge and the removable frame comprise polyphenylene sulfide.

6. The shaver according to claim 1, wherein the resilient arms are secured to the removable frame.

7. The shaver according to claim 1, wherein the removable frame with the upper and lower blade and with the resilient arms and the oscillating bridge form a structural unit, that the structural unit is detachably secured to a pivot frame, that the pivot frame is pivotally mounted on a head support (24) and that the head support is part of a shaver housing.

8. The shaver according to claim 7, wherein both the head support and the pivot frame are penetrated by a connecting member, that the lower end has a longitudinal slot into which a cam engages and that the end protruding from the pivot frame engages into a receptacle.

9. The shaver according to claim 8, wherein the connecting link is formed by a rocker arm and that the rocker arm is mounted to be capable of pivoting around an axis of rotation.

10. The shaver according to claim 9, wherein the rotational axis lies on the central axis of the rocker arm.

11. The shaver according to claim 10, wherein, when the shaver is at rest, the rotational axis is designed to be at the point on the axis of symmetry of the rocker arm at which the extensions of the longitudinal axes of the resilient arms meet.

12. The shaver according to claim 11, wherein the rotational axis runs perpendicular to the linear oscillating motion of the lower blade.

13. The shaver according to claim 12, wherein the rotational axis is formed on one side by a hole passing through the rocker arm and on the other side by an alignment pin sliding through the hole, wherein the alignment pin is secured to the pivot frame.

14. A removable cutting device for an electrically driven shaver consisting of at least one upper and lower blade in a removable frame wherein the lower blade is attached to an oscillating bridge via a clutch, which in turn is coupled via a gear mechanism to an electric drive, wherein the oscillating bridge is connected to the shaver by means of resilient arms, wherein the resilient arms of the oscillating bridge are secured to the removable frame.

15. A removable cutting device according to claim 14, wherein the resilient arms with the oscillating bridge are integrally joined to the removable frame.
